(19) United States
(12) Patent Application Publication
(10) Pub. No.: US 2016/0271764 A1
(43) Pub. Date: Sep. 22, 2016

(54) Remover for sparker plug

(71) Applicant: Chia Hao Huang, Taichung City (TW)

(72) Inventor: Chia Hao Huang, Taichung City (TW)

(73) Assignee: POUL CHANG METAL INDUSTRY CO., LTD., Taichung City (TW)

(21) Appl. No.: 14/663,473

(22) Filed: Mar. 20, 2015

(51) Int. Cl. B25B 13/48; B25B 27/18; B25B 13/54

(52) U.S. Cl. CPC B25B 13/483; B25B 13/54; B25B 27/18

(57) ABSTRACT

A remover for a sparker plug contains: an outer pipe, a pressing tube, a push rod, and a rotating lever. The outer pipe includes a first operating segment, a second operating segment, and a hollow cavity. The pressing tube abuts against the first operating segment and includes a hollow chamber communicating with the hollow cavity. The push rod is inserted through the hollow cavity and the hollow chamber. The push rod includes a raised section extending out of the pressing tube and includes a threaded section extending out of the second operating segment, wherein a diameter of the raised section is larger than the hollow chamber, and the push rod further includes a tilted guiding face formed on one end thereof adjacent to the raised section. The rotating lever abuts against the second operating segment of the outer pipe and screwing with the threaded section of the push rod.

### FIELD OF THE INVENTION

The present invention relates to a remover which is employed to remove a broken sparker plug from an engine cylinder easily.

### BACKGROUND OF THE INVENTION

A conventional sparker plug is fixed in an ignition system of a vehicle or an internal combustion engine, wherein a first discharge surface of a central electrode discharges high voltage provided by an ignition coil to a second discharge surface of ground electrode, thus starting an engine cylinder.

The sparker plug is removed from or connected with the engine cylinder by a socket, but when the sparker plug is broken or aged, it is difficult to be removed from the engine cylinder for replacement.

The present invention has arisen to mitigate and/or obviate the afore-described disadvantages.

### SUMMARY OF THE INVENTION

The primary objective of the present invention is to provide a remover which is employed to remove a broken sparker plug from an engine cylinder easily.

To obtain the above objective, a remover for a sparker plug provided by the present invention contains: an outer pipe, a pressing tube, a push rod, and a rotating lever.

The outer pipe includes a first operating segment formed on a first end thereof and a second operating segment formed on a second end thereof, the outer pipe also includes a hollow cavity defined therein and communicating with the first operating segment and the second operating segment.

The pressing tube is biased against the first operating segment of the outer pipe and includes a hollow chamber defined therein and communicating with the hollow cavity of the outer pipe.

The push rod is inserted through the hollow cavity and the hollow chamber and includes a raised section extending out of the pressing tube, the push rod also includes a threaded section extending out of the second operating segment, wherein a diameter of the raised section is larger than that of the hollow chamber, the push rod further includes a tilted guiding face formed on one end thereof adjacent to the raised section.

The rotating lever abuts against the second operating segment of the outer pipe and screwing with the threaded section of the push rod.

In operation, the pressing tube and the raised section are inserted into the broken sparker plug, wherein a most part of the outer pipe is fixed outside the engine cylinder, and the rotating lever pulls the push rod, such that the tilted guiding face presses an inner wall of the pressing tube (in the meantime, the push rod limits a rotation of the pressing tube). Furthermore, as rotating the rotating lever, it pushes the push rod so that the raised section forces the pressing tube to press an inner surface of the broken sparker plug, thereafter the outer pipe pulls the broken sparker plug out of the engine cylinder.

Preferably, the pressing tube further includes at least one stress slot defined on one end thereof which corresponds to the raised section of the push rod.

Preferably, the pressing tube further includes a plurality of fixing ribs arranged around an outer wall thereof.

Preferably, the outer pipe further includes screwing threads formed on an outer wall of the first operating segment.

Preferably, the outer pipe further includes a polygonal section formed on the second operating segment thereof, and the rotating lever is formed in a polygon shape.

Preferably, the hollow cavity has an inner diameter section defined in the second end of the outer pipe on which the second operating segment is formed, and the outer pipe further includes a bearing accommodated in the inner diameter section, the bearing has a through orifice formed on a central position thereof to insert the push rod, and the inner diameter section of the outer pipe has a peripheral groove defined adjacent to an opening thereof, wherein the peripheral groove has a C retainer mounted therein and retaining with the bearing.

### BRIEF DESCRIPTION OF THE DRAWINGS

FIG. 1 is a perspective view showing the exploded components of a remover for a sparker plug according to a preferred embodiment of the present invention.

FIG. 2 is a perspective view showing the assembly of the remover for the sparker plug according to the preferred embodiment of the present invention.

FIG. 3 is a cross sectional view showing the operation of the remover for the sparker plug according to the preferred embodiment of the present invention.

FIG. 4 is another cross sectional view showing the operation of the remover for the sparker plug according to the preferred embodiment of the present invention.

FIG. 5 is also another cross sectional view showing the operation of the remover for the sparker plug according to the preferred embodiment of the present invention.

FIG. 6 is still another cross sectional view showing the operation of the remover for the sparker plug according to the preferred embodiment of the present invention.

### DETAILED DESCRIPTION OF THE PREFERRED EMBODIMENTS

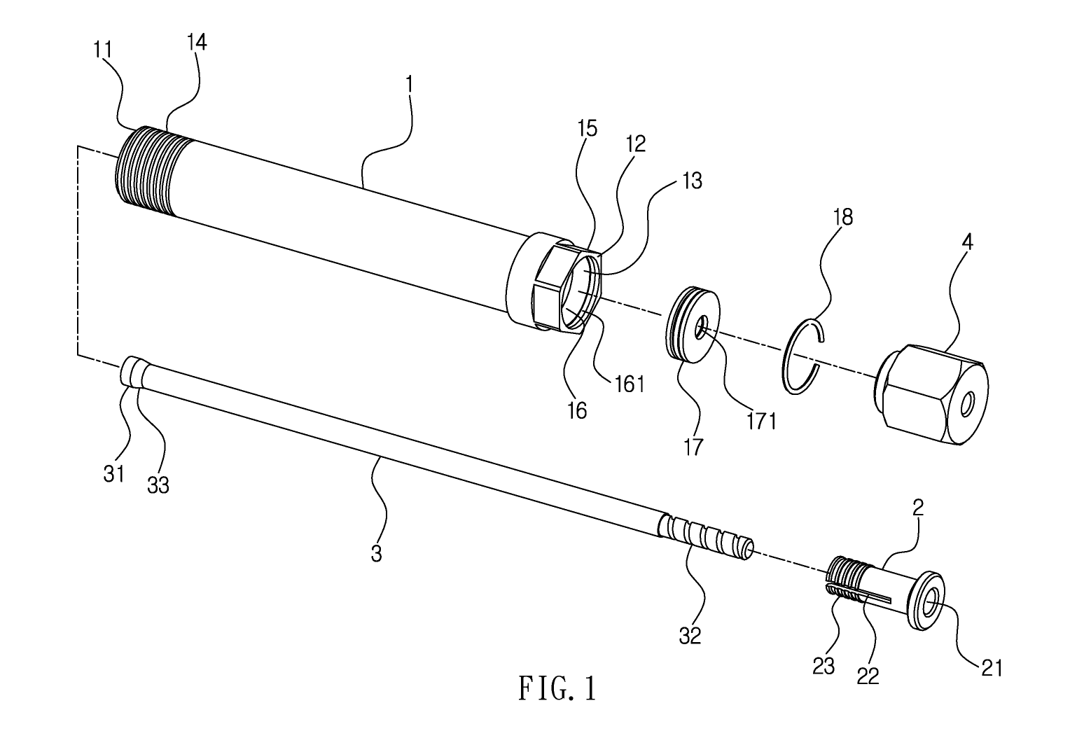

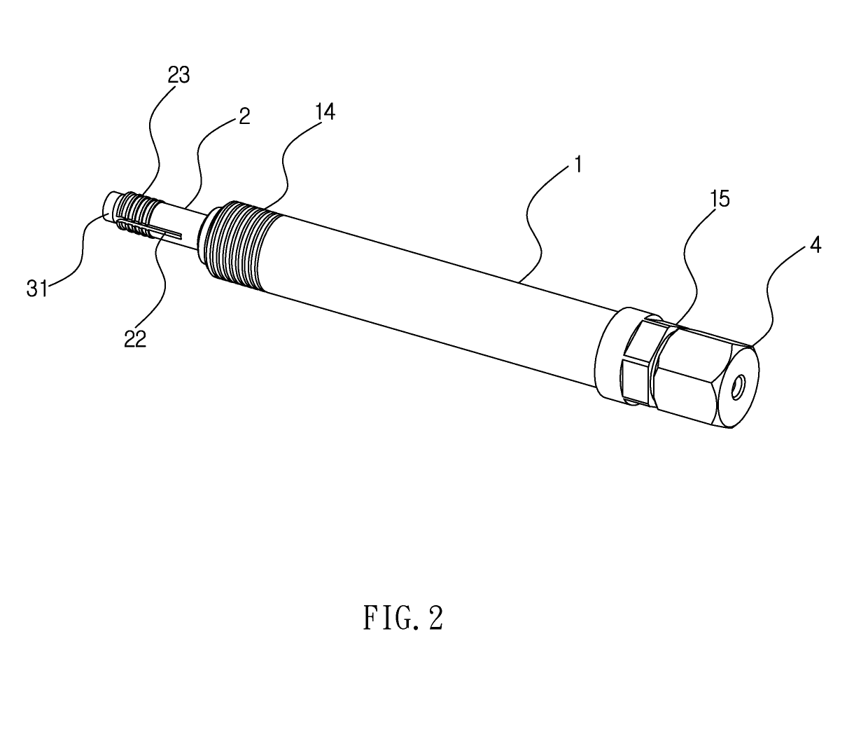

With reference to FIGS. 1 and 2, a remover according to a preferred embodiment of the present invention is employed to remove a broken sparker plug from an engine cylinder and comprises: an outer pipe 1, a pressing tube 2, a push rod 3, and a rotating lever 4.

The outer pipe 1 includes a first operating segment 11 formed on a first end thereof and includes a second operating segment 12 formed on a second end thereof, the outer pipe 1 also includes a hollow cavity 13 defined therein and communicating with the first operating segment 11 and the second operating segment 12. The pressing tube 2 is biased against the first operating segment 11 of the outer pipe 1 and includes a hollow chamber 21 defined therein and communicating with the hollow cavity 12 of the outer pipe 1. The push rod 3 is inserted through the hollow cavity 13 and the hollow chamber 21 and includes a raised section 31 extending out of the pressing tube 2, the push rod 3 also includes a threaded section 32 extending out of the second operating segment 12, wherein a diameter of the raised section 31 is larger than that of the hollow chamber 21. The push rod 3 further includes a tilted guiding face 33 formed on one end thereof adjacent to the raised section 31. The rotating lever 4 abuts against the second operating segment 12 of the outer pipe 1 and screwing with the threaded section 32 of the push rod 3.

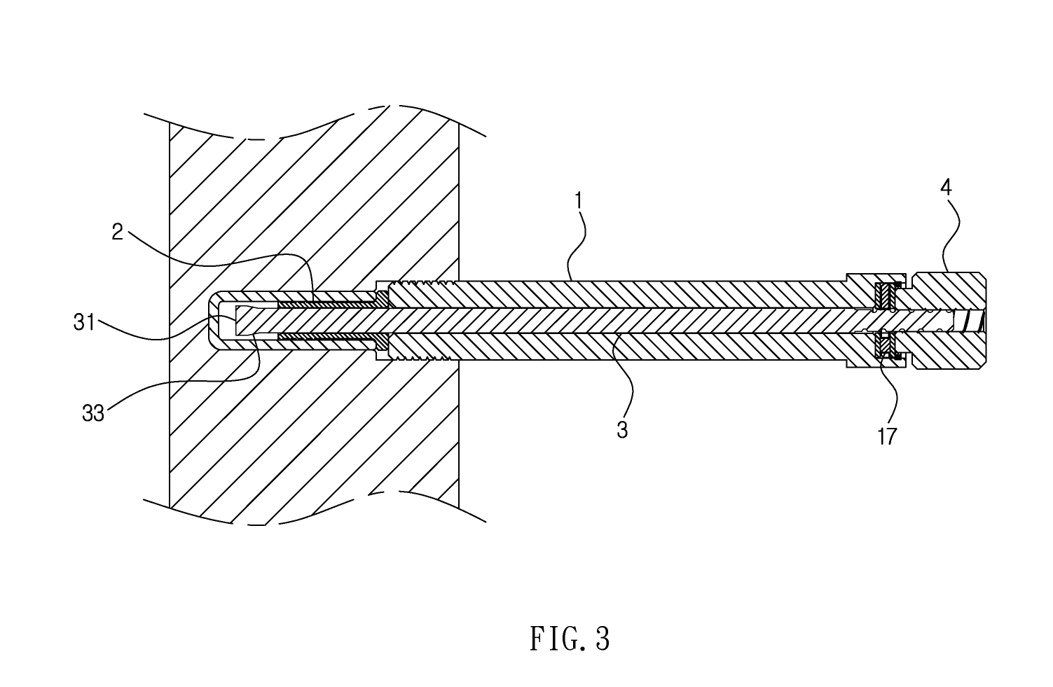

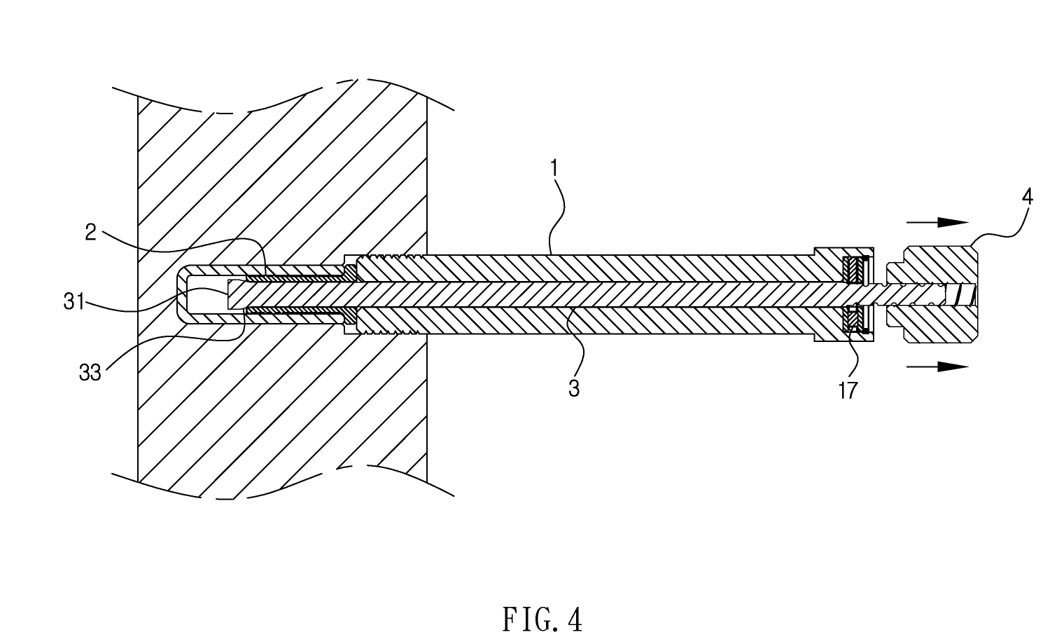

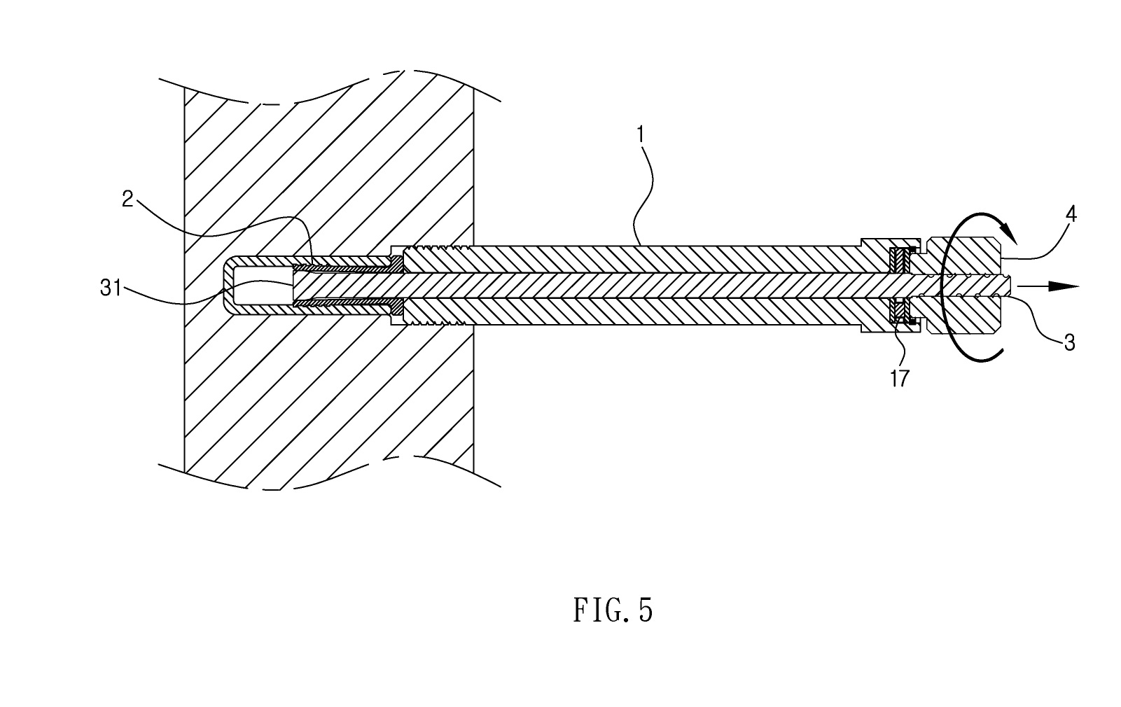

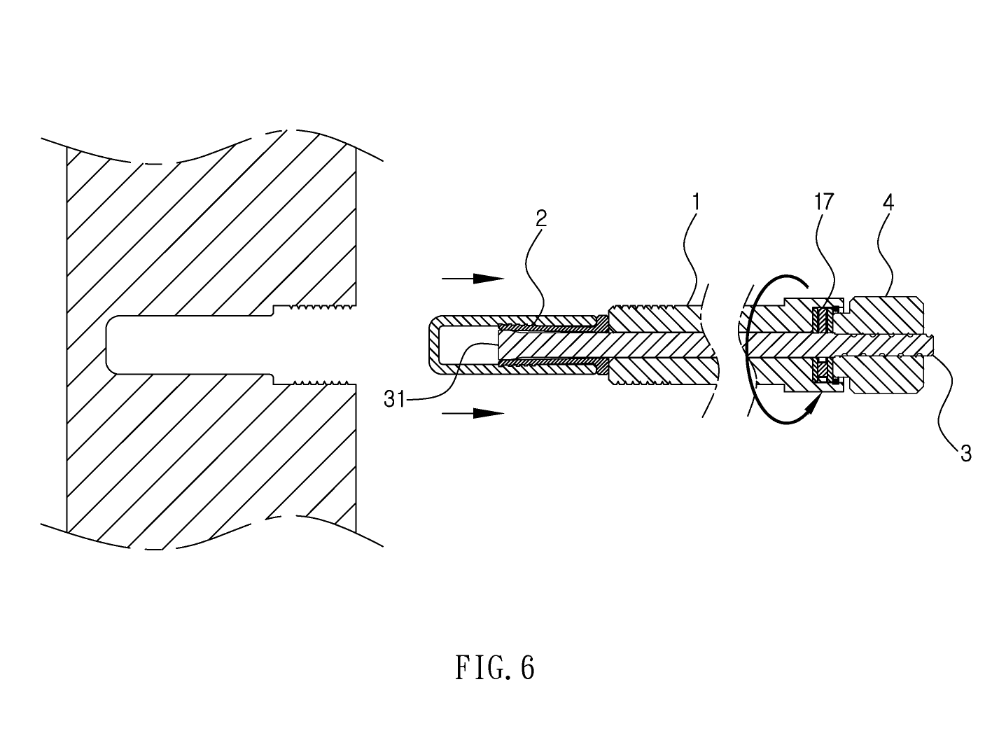

Referring to FIGS. 3 to 6, the pressing tube 2 and the raised section 31 are inserted into the broken sparker plug, wherein a most part of the outer pipe 1 is fixed outside the engine cylinder (as shown in FIG. 3), and the rotating lever 4 pulls the push rod 3, such that the tilted guiding face 33 presses an inner wall of the pressing tube 2 (in the meantime, as illustrated in FIG. 4, the push rod 3 limits a rotation of the pressing tube 2). Furthermore, as rotating the rotating lever 4, it pushes the push rod 3 so that the raised section 31 forces the pressing tube 2 to press an inner surface of the broken sparker plug (as shown in FIG. 5), thereafter the outer pipe 1 pulls the broken sparker plug (as shown in FIG. 6).

Preferably, the pressing tube 2 further includes at least one stress slot 22 defined on one end thereof which corresponds to the raised section 31 of the push rod 3, such that the raised section 31 pushes the inner wall of the pressing tube 2, thus deforming the pressing tube 2.

The pressing tube 2 further includes a plurality of fixing ribs 23 arranged around an outer wall thereof, such that a friction force is provided by the plurality of fixing ribs 23 to pull the broken sparker plug easily, when the pressing tube 2 forces an inner wall of the broken sparker plug.

The outer pipe 1 further includes screwing threads 14 formed on an outer wall of the first operating segment 11, such that the outer pipe 1 is connected with the engine cylinder by using the screwing threads 14, thereby removing the broken sparker plug from the engine cylinder easily.

The outer pipe 1 further includes a polygonal section 15 formed on the second operating segment 12 thereof, and the rotating lever 4 is formed in a polygon shape, such that the rotating lever 4 is rotated by a wrench or a socket, the polygonal section 15 of the outer pipe 1 is rotated by the wrench or the socket, and the screwing threads 14 are screwed with the engine cylinder to pull the broken sparker plug out of the engine cylinder.

The hollow cavity 13 has an inner diameter section 16 defined in the second end of the outer pipe 1 on which the second operating segment 12 is formed, and the outer pipe 1 further includes a bearing 17 accommodated in the inner diameter section 16, the bearing 17 has a through orifice 171 formed on a central position thereof to insert the push rod 3, and the inner diameter section 16 of the outer pipe 1 has a peripheral groove 161 defined adjacent to an opening thereof, wherein the peripheral groove 161 has a C retainer 18 mounted therein and retaining with the bearing 17, such that the outer pipe 1 contacts with the rotating lever 4 by ways of the bearing 17 to rotate and pull the push rod 3 easily.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A remover for a sparker plug comprising: an outer pipe, a pressing tube, a push rod, and a rotating lever, wherein
the outer pipe includes a first operating segment formed on a first end thereof and a second operating segment formed on a second end thereof, the outer pipe also includes a hollow cavity defined therein and communicating with the first operating segment and the second operating segment;
the pressing tube is biased against the first operating segment of the outer pipe and includes a hollow chamber defined therein and communicating with the hollow cavity of the outer pipe;
the push rod is inserted through the hollow cavity and the hollow chamber and includes a raised section extending out of the pressing tube, the push rod also includes a threaded section extending out of the second operating segment, wherein a diameter of the raised section is larger than that of the hollow chamber, the push rod further includes a tilted guiding face formed on one end thereof adjacent to the raised section;
the rotating lever abuts against the second operating segment of the outer pipe and screwing with the threaded section of the push rod.

2. The remover for the sparker plug as claimed in claim 1, wherein the pressing tube further includes at least one stress slot defined on one end thereof which corresponds to the raised section of the push rod.

3. The remover for the sparker plug as claimed in claim 1, wherein the pressing tube further includes a plurality of fixing ribs arranged around an outer wall thereof.

4. The remover for the sparker plug as claimed in claim 1, wherein the outer pipe further includes screwing threads formed on an outer wall of the first operating segment.

5. The remover for the sparker plug as claimed in claim 1, wherein the outer pipe further includes a polygonal section formed on the second operating segment thereof, and the rotating lever is formed in a polygon shape.

6. The remover for the sparker plug as claimed in claim 1, wherein the hollow cavity has an inner diameter section defined in the second end of the outer pipe on which the second operating segment is formed, and the outer pipe further includes a bearing accommodated in the inner diameter section, the bearing has a through orifice formed on a central position thereof to insert the push rod, and the inner diameter section of the outer pipe has a peripheral groove defined adjacent to an opening thereof, wherein the peripheral groove has a C retainer mounted therein and retaining with the bearing.
